(19) United States
(12) Patent Application Publication
(10) Pub. No.: US 2026/0010276 A1
(43) Pub. Date: Jan. 8, 2026

(54) METHOD FOR DISPLAYING ITEMS AND ELECTRONIC DEVICE SUPPORTING THE SAME

(71) Applicant: SAMSUNG ELECTRONICS CO., LTD., Suwon-si (KR)

(72) Inventors: Hyemi YU, Suwon-si (KR); Hyunggwang KANG, Suwon-si (KR); Moonsoo KIM, Suwon-si (KR); Jihun MUN, Suwon-si (KR); Hyungjin SON, Suwon-si (KR); Nagyeom YOO, Suwon-si (KR)

(73) Assignee: SAMSUNG ELECTRONICS CO., LTD., Suwon-si (KR)

(21) Appl. No.: 19/256,782

(22) Filed: Jul. 1, 2025

Related U.S. Application Data
(63) Continuation of application No. PCT/KR2025/009119, filed on Jun. 27, 2025.

(30) Foreign Application Priority Data
Jul. 1, 2024 (KR) 10-2024-0086088
Aug. 19, 2024 (KR) 10-2024-0110691

(51) Int. Cl. G06F 3/04817; G06F 3/04883

(52) U.S. Cl. CPC G06F 3/04817; G06F 3/04883

(57) ABSTRACT

An electronic device disclosed herein may include a display, a memory, and at least one processor including processing circuitry. The memory may store instructions that, when individually or collectively executed by the at least one processor, cause the electronic device to determine an item group, the item group including at least one icon for executing an application installed in the electronic device, receive a gesture input of a user through the display, determine a first object corresponding to the gesture input, and arrange one or more items included in the item group on the display based on a shape of the first object.

### CROSS-REFERENCES TO RELATED APPLICATIONS

This application is a continuation of International Application No. PCT/KR2025/009119, filed on Jun. 27, 2025, with the Korean Intellectual Property Office, which claims priority to Korean Patent Application No. 10-2024-0086088, filed on Jul. 1, 2024, and Korean Patent Application No. 10-2024-0110691, filed on Aug. 19, 2024, with the Korean Intellectual Property Office, the disclosures of which are incorporated by reference herein in their entireties.

### BACKGROUND

### 1. Field

Various embodiments disclosed herein relate to a method for displaying items on a display and an electronic device supporting the same.

### 2. Related Art

Various portable electronic devices such as smartphones and tablet PCs are being released. Electronic devices may perform various functions, such as making calls, surfing the Internet, playing videos, or playing music, using applications.

A home screen of an electronic device may display various items. For example, items (or contents) such as icons, stickers (sticker images), and widgets for executing applications may be displayed on the home screen.

In recent years, devices whose display size is capable of being expanded or reduced, such as foldable devices or rollable devices, have been released. When the size of the display is expanded, the positioning of the items displayed on the home screen are maintained or the items are simply rearranged. Alternatively, when the size of the display is reduced, the items displayed on the home screen simply return to the item disposition before the display is expanded.

### SUMMARY

An electronic device according to an embodiment includes a display, a memory, and at least one processor including processing circuitry. The memory stores one or more instructions that, when individually or collectively executed by the at least one processor, cause the electronic device to determine an item group, the item group including at least one icon for executing an application installed in the electronic device, receive a gesture input of a user through the display, determine a first object corresponding to the gesture input, and arrange one or more items included in the item group on the display based on a shape of the first object.

A method for displaying items according to an embodiment is performed on an electronic device and includes determining an item group, the item group including at least one icon for executing an application installed in the electronic device, receiving a gesture input of a user through a display of the electronic device, determining a first object corresponding to the gesture input, and arranging one or more items included in the item group on the display based on a shape of the first object.

A non-transitory computer-readable medium storing instructions that when individually or collectively executed by the at least one processor of an electronic device, cause the electronic device to determine an item group, the item group including at least one icon for executing an application installed in the electronic device, receive a gesture input of a user through the display, determine a first object corresponding to the gesture input, and arrange one or more items included in the item group on the display based on a shape of the first object.

### BRIEF DESCRIPTION OF DRAWINGS

FIG. 1 is a block diagram illustrating an electronic device in a network environment according to various embodiments.

FIG. 2 is a flowchart illustrating a process for displaying items according to an embodiment.

FIGS. 3A to 3C each illustrate a home screen displayed on an electronic device in which a display is expanded according to an embodiment.

FIG. 4 illustrates a home screen displayed on the electronic device in which the display is reduced according to an embodiment.

FIG. 5 illustrates a home screen on which widgets are disposed according to an embodiment.

FIG. 6 illustrates a home screen on which stickers and widgets are disposed according to an embodiment.

FIG. 7 illustrates a home screen with grid constraint according to an embodiment.

FIG. 8 illustrates a home screen on which items are disposed in real time according to an embodiment.

FIG. 9 illustrates a home screen without grid constraint according to an embodiment.

FIG. 10 illustrates a home screen without grid constraint and having items disposed in real time according to an embodiment.

FIG. 11 illustrates a home screen according to widget disposition according to an embodiment.

FIG. 12 illustrates a home screen according to a gesture and the number of items according to an embodiment.

FIG. 13 illustrates a home screen according to a gesture and the number of items according to an embodiment.

FIG. 14 illustrates a home screen according to a gesture and the number of items according to an embodiment.

FIG. 15 illustrates a home screen that receives a gesture input for each page according to an embodiment.

FIG. 16 illustrates a home screen according to a change in a background image according to an embodiment.

FIG. 17 illustrates settings of a home screen according to an embodiment.

With respect to the description of the drawings, the same or similar reference signs may be used for the same or similar elements.

### DETAILED DISCLOSURE

Hereinafter, various embodiments of the present disclosure will be described with reference to the accompanying drawings. However, this is not intended to limit the present disclosure to the specific embodiments, and it is to be construed to include various modifications, equivalents, and/or alternatives of embodiments of the present disclosure. With regard to the description of the drawings, similar reference numerals may be used to refer to similar elements.

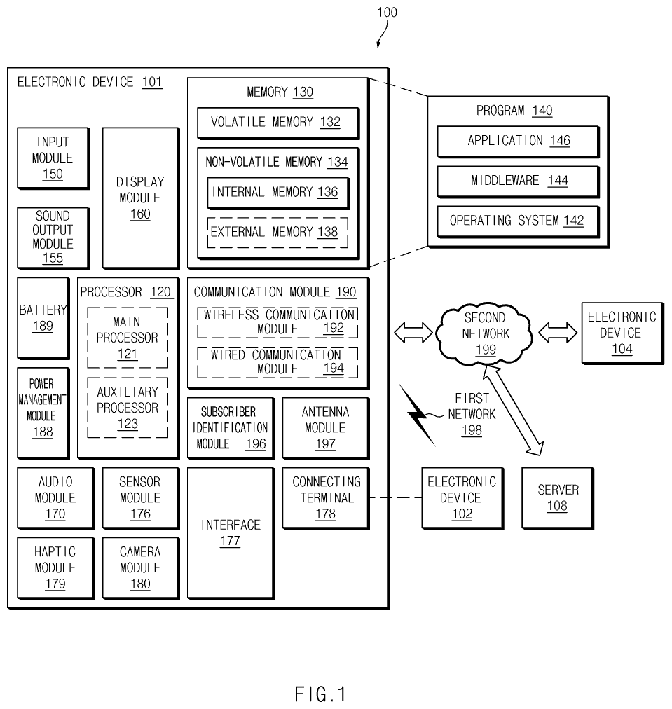

FIG. 1 is a block diagram illustrating an electronic device 101 in a network environment 100 according to various embodiments. Referring to FIG. 1, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thererto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mm Wave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mm Wave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

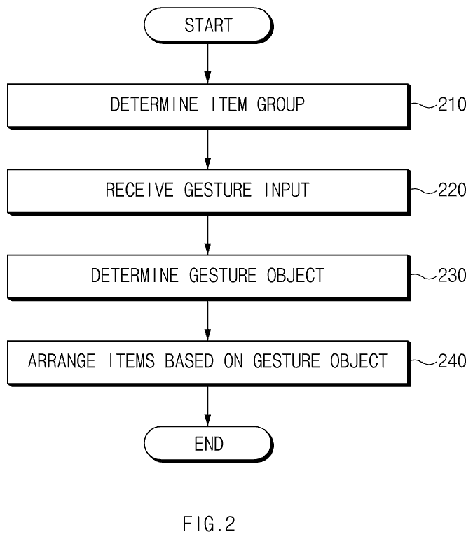

FIG. 2 is a flowchart illustrating a method for displaying items according to an embodiment.

Referring to FIGS. 1 and 2, in operation 210, the processor 120 may determine an item group including at least one item. The at least one item may include an icon for executing an application installed on the electronic device 101. Alternatively, the at least one item may include a folder icon for opening a specific folder or a sticker image.

According to an embodiment, the processor 120 may determine items selected by user input from a list of applications (hereinafter, “app list”) installed in the electronic device 101 as an item group.

According to an embodiment, the processor 120 may determine items currently displayed on the home screen as an item group.

According to an embodiment, the processor 120 may determine items included in the item group based on information about the way or history of a user using the electronic device 101. For example, the processor 120 may include icons of applications that the user has frequently executed or has recently used frequently in the item group.

In operation 220, the processor 120 may receive a gesture input (or an interaction input) of the user through the display 160. The gesture input may be an input that involves touching the display 160 with a part of a user's body and moving the part while drawing a line, a figure, or shape.

According to an embodiment, the gesture input may occur after selecting the item group in the app list. Alternatively, the gesture input may occur after a specified condition on the home screen is satisfied (e.g., a long-touch input occurs on the home screen). Alternatively, the gesture input may be a plurality of touch inputs occurring within a specified time period or within a specified number of times.

In operation 230, the processor 120 may determine an object (hereinafter, gesture object) corresponding to the gesture input. The processor 120 may determine a gesture object that has a high similarity to the form of the gesture input.

For example, the processor 120 may compare at least a portion of the gesture input with an object recognized on a webpage frequently visited by the user, an object recognized in a gallery app displaying captured images, or an object included in a pre-stored database related to the gesture input (e.g., boundary comparing (outermost boundary, inner boundary), center portion comparing, or specific portion comparing). For example, the processor 120 may determine an object having an outermost boundary that has a high similarity to the gesture input as the gesture object. However, the gesture object is not limited thereto, and may be determined by comparing the similarity between objects in various ways.

According to an embodiment, the processor 120 may determine a line, such as a curve or a straight line, corresponding to a gesture input as the gesture object. In this case, the processor 120 may determine information (e.g., the length, size, or shape) on a line that is the gesture object based on information (e.g., the movement distance, thickness, and shape) about the gesture input.

In operation 240, the processor 120 may arrange items included in the item group on the display 160 based on the shape of the gesture object corresponding to the gesture input. For example, when the gesture object is determined to be an animal character, the processor 120 may arrange the items included in the item group along the boundary of the animal character on the display 160. For another example, when the gesture object is determined to be a line such as a curve or a straight line, the processor 120 may arrange the items included in the item group along the line of the gesture object on the display 160.

According to an embodiment, the processor 120 may arrange the items included in the item group along the gesture object, and additionally dispose other items (e.g., stickers, widgets) inside, outside, or around the gesture object in various ways.

According to an embodiment, in the case of a foldable/rollable device, the processor 120 may check whether a display region (an active region, an area where items are disposed on the home screen) is expanded or reduced. The processor 120 may modify the gesture object in response to expansion or reduction of the display region and dispose the items based on the modified gesture object.

Additional information regarding how the processor 120 disposes items including stickers, widgets or icons based on the gesture input may be provided through the drawings below.

Below, various embodiments may be provided in which items are disposed on the home screen by a gesture input of the user. The embodiments may be combined in various ways. For example, the processor 120 may apply an artificial intelligence (AI) model or logic to dispose items including icons, stickers, or widgets on the home screen in various manners based on the gesture input.

Below, the discussion focuses on, but is not limited to, cases where a gesture input occurs on the home screen. For example, a gesture input may be an input that occurs on a locked screen or a screen that is turned off.

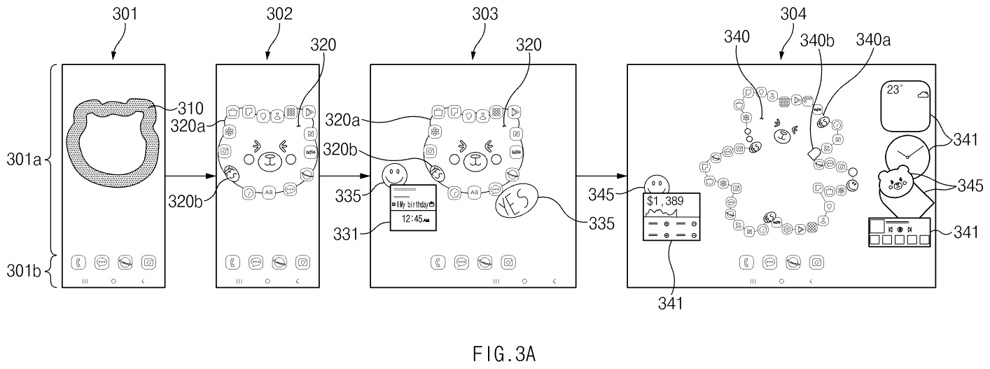

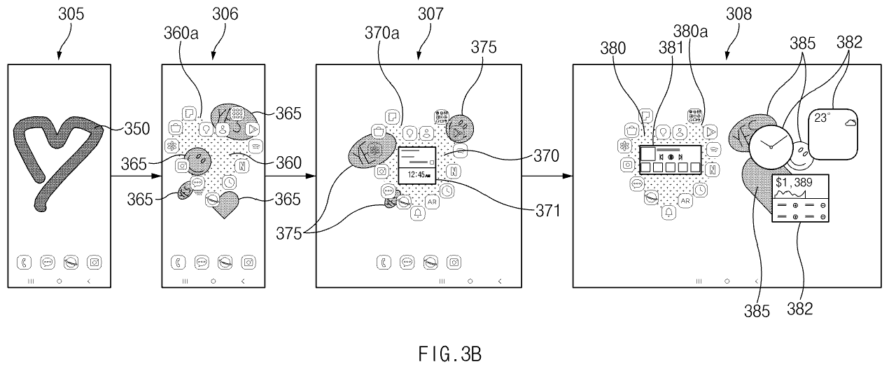

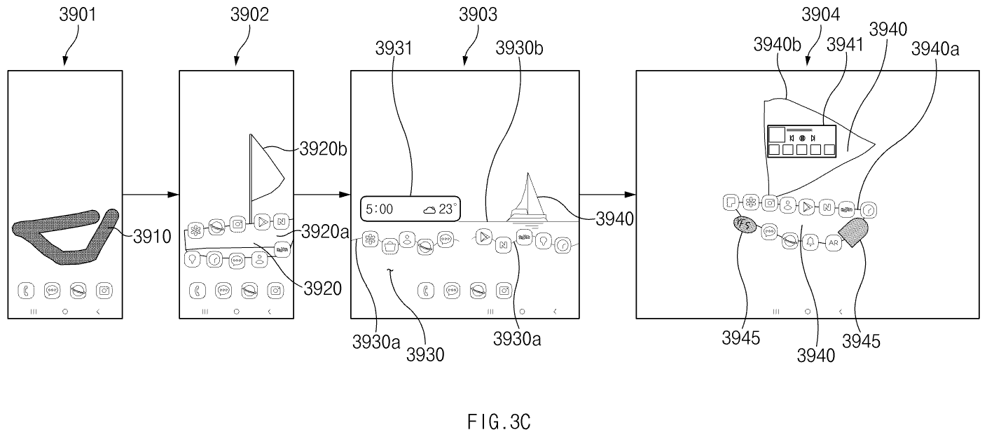

FIGS. 3A to 3C each illustrate a home screen displayed on an electronic device in which a display is expanded according to an embodiment.

Referring to FIG. 1 and FIG. 3A, a first screen 301 and a second screen 302 may be home screens displayed when the display 160 of the electronic device 101 is in a first state (or a reduced state, a minimized state).

In the first screen 301, the processor 120 may receive a gesture input (or an interaction input) 310 of the user. The gesture input 310 may be an input that involves touching the display 160 with a part of a user's body and moving the part while drawing a line, a figure, or a shape.

According to an embodiment, the display 160 may include a first display region 301a and a second display region 301b. The first display region 301a may be a region with a relatively large area and having a large number of items disposed therein. The second display region 301b may be a region with a relatively small area and having a small number of frequently used items disposed therein. The gesture input 310 may be an input that occurs in the first display region 301a of the display 160.

In the second screen 302, the processor 120 may determine a gesture object 320 (e.g., a shape, a figure, a character) corresponding to the gesture input 310 of the user. The processor 120 may determine the gesture object 320 having a shape or line similar to the shape or line of the gesture input 310 of the user.

According to an embodiment, the processor 120 may determine the gesture object 320 by reflecting a user's preference. For example, the processor 120 may compare the gesture input 310 with an object recognized on a webpage frequently visited by the user, an object recognized in a gallery app displaying captured images, or an object included in a pre-stored database related to the gesture input 310. The processor 120 may determine an object with a high similarity to the gesture input 310 as the gesture object 320.

According to an embodiment, the processor 120 may store pre-training information about the user. For example, the processor 120 may analyze a pattern of the user using the electronic device 101 to generate and store pre-training information about the preference for shapes, figures, characters, or animals preferred by the user. The processor 120 may determine the gesture object 320 with high preference for each user determined based on pre-training information about the user.

For example, the processor 120 may input personal information (e.g., an age, a gender) about the user into an artificial intelligence model within the electronic device 101 to determine the gesture object 320. The processor 120 may determine the preference of each user based on pre-training information about the user (e.g., information on the shapes, animals, or persons preferred by the user) and determine the gesture object 320 corresponding to the preference of each user.

For example, even when the same shape is drawn, the processor 120 may determine the gesture object 320 as a bear character for a user A and as a cat character for a user B according to the preference according to pre-training information about each user.

According to an embodiment, the processor 120 may reflect the shape of the gesture object 320 to dispose items on at least a portion of the boundary, interior, or exterior of the gesture object 320. For example, the processor 120 may dispose the items along an object boundary 320a of the gesture object 320. The disposed items may be icons that execute applications, folder icons, or stickers (sticker images). The operation of disposing the items along the object boundary 320a may include an operation of disposing the items in a shape or pattern similar to the gesture object 320.

Hereinafter, the discussion will focus on a case of disposing the items along the boundary 320a of the gesture object 320, but not be limited thereto.

According to an embodiment, the processor 120 may dispose items selected by a separate user input along the object boundary 320a before generating the gesture input 310. Alternatively, the processor 120 may dispose the items disposed on the home screen before the gesture input 310 occurs along the object boundary 320a.

According to an embodiment, when the total length of the items disposed along the object boundary 320a is shorter than the length of the object boundary 320a, the processor 120 may dispose at least one sticker 320b along the object boundary 320a together with the items. Conversely, when the total length of the disposed items is longer than the length of the object boundary 320a, the processor 120 may generate a folder and store items exceeding the length of the object boundary 320a in the folder. The processor 120 may dispose a folder icon together with the items on the object boundary 320a.

According to an embodiment, a third screen 303 may be a home screen displayed in a second state (or a first expanded state) in which the display 160 of the electronic device 101 is primarily expanded. In the second state, the display region where the items are displayed may be expanded compared to the first state. For example, the third screen 303 may be displayed when the foldable device is unfolded or when the rollable device is slid and unfolded.

According to an embodiment, in the third screen 303, the processor 120 may dispose the items along the object boundary 320a of the gesture object 320 in the same or similar manner as in the second screen 302. The processor 120 may maintain a disposed form of the gesture object 320 and the items in the same manner as the second screen 302, or may partially change the disposed form of the items by partially enlarging the gesture object 320.

According to an embodiment, the processor 120 may input, together with information about the gesture object 320 (e.g., an object type, characteristics), information about the size of the display (e.g., a change in the size of the display region of the display) and the like into a generative artificial intelligence to determine an image, an object, and items to be disposed on the third screen 303. According to an embodiment, as an example of an operation of determining an image, an object, and items to be disposed on the third screen 303, the processor 120 may enlarge or reduce and display the size of at least a portion of a gesture object 320, in proportion to a change in the size of the display region of the display.

According to an embodiment, the processor 120 may add a widget 331 or a separate background sticker 335 to an empty space around the gesture object 320. The widget 331 may be disposed separately so as not to overlap the gesture object 320 outside the gesture object 320. The background sticker 335 may be disposed separately so as not to overlap the gesture object 320, or may be disposed so that at least a portion thereof overlaps the gesture object 320. The background sticker 335 may have a different shape or size from the sticker 320b disposed along the object boundary 320a.

According to an embodiment, a fourth screen 304 may be a home screen displayed in a third state (or a second expanded state, a maximum expanded state) in which the display 160 of the electronic device 101 is secondarily expanded. In the third state, the display region where the items are displayed may be expanded compared to the second state.

According to an embodiment, in the fourth screen 304, the processor 120 may display an expanded object 340 associated with the gesture object 320. The expanded object 340 may be similar to the gesture object 320 and may be an object having a greater size. For example, when the gesture object 320 is a bear's face, the expanded object 340 may have a shape that includes both the bear's face and body.

According to an embodiment, the processor 120 may dispose the items along a boundary 340a of the expanded object 340. The length of the boundary 340a may be longer than the object boundary 320a of the gesture object 320. In the third state, the processor 120 may dispose a greater number of items (icons or stickers) than in the second state. The processor 120 may additionally dispose icons of applications with high usage frequency or high usability among icons that are not selected by the user along the boundary 340a. Alternatively, the processor 120 may pull out some of the icons contained in a folder in the second screen 302 or the third screen 303 to the home screen and dispose them along the boundary 340a, or may pull out all the icons contained in the folder to the home screen and dispose them along the boundary 340a and temporarily delete the folder.

The processor 120 may add a widget 341 or a separate background sticker 345 to an empty space around the expanded object 340. The widget 341 may be disposed separately so as not to overlap the expanded object 340 outside the expanded object 340. Alternatively, the widget 331 may be disposed so as not to overlap the items disposed along the boundary 340a or an object boundary 324a inside the expanded object 340.

According to an embodiment, the background sticker 345 may be disposed separately so as not to overlap the expanded object 340, or may be disposed so that at least a portion thereof overlaps the expanded object 340. The background sticker 345 may have a different shape or size from a sticker 340b disposed along the boundary 340a. The background sticker 345 may be displayed to overlap the items along the boundary 340a, and may be a part of the background image.

Referring to FIG. 1 and FIG. 3B, a fifth screen 305 and a sixth screen 306 may be home screens displayed on the display 160 of the electronic device 101 in the first state (or the reduced state, the minimized state).

According to an embodiment, in the fifth screen 305, the processor 120 may receive a gesture input 350 of the user. The gesture input 350 may be an input that involves touching the display 160 with a part of a user's body and moving the part while drawing a line, a figure, or a shape.

According to an embodiment, in the sixth screen 306, the processor 120 may determine a gesture object (e.g., a shape, a figure, a character) 360 corresponding to the gesture input 350 of the user. The processor 120 may determine the gesture object 360 (e.g., a heart) similar to the shape or line of the gesture input 350 of the user.

According to an embodiment, the processor 120 may dispose the items along the object boundary 360a of the gesture object 360. For example, the disposed items may be icons that execute applications, folder icons, or stickers.

According to an embodiment, the processor 120 may additionally display a separate background sticker 365 in an empty space around the gesture object 360. The background sticker 365 may be disposed separately so as not to overlap the gesture object 360, or may be disposed so that at least a portion thereof overlaps the gesture object 360. The background sticker 365 may be a part of the background, and may be disposed on a lower layer so as not to obscure the disposed items.

According to an embodiment, a seventh screen 307 may be a home screen displayed in the second state (or the first expanded state) in which the display 160 of the electronic device 101 is primarily expanded. In the second state, the display region where the items are displayed may be expanded compared to the first state.

In the seventh screen 307, the processor 120 may display a first expanded object 370 in which the gesture object 360 is enlarged. The first expanded object 370 may have a shape identical to or similar to that of the gesture object 360, and may be an object having a greater size than the gesture object 360. The size of the first expanded object 370 may be determined according to the size of the display on which the seventh screen 307 is displayed (e.g., the display region of the display). The processor 120 may dispose the items along an object boundary 370a of the first expanded object 370.

According to an embodiment, the processor 120 may add a widget 371 or a separate background sticker 375 to an empty space outside the first expanded object 370 or inside the first expanded object 370. For example, the widget 371 may be disposed within the first expanded object 370 so as not to overlap the object boundary 370a, or items disposed along the object boundary 370a. The background sticker 375 may be disposed to overlap the first expanded object 370 and displayed as a part of the background.

According to an embodiment, an eighth screen 308 may be a home screen displayed in the third state (or the second expanded state, the maximum expanded state) in which the display 160 of the electronic device 101 is secondarily expanded. In the third state, the display region where the items are displayed may be expanded compared to the second state.

According to an embodiment, in the eighth screen 308, the processor 120 may display a second expanded object 380 obtained by enlarging the first expanded object 370. The second expanded object 380 may have a shape identical to or similar to that of the gesture object 360 or the first expanded object 370, and may be an object having a greater size than the gesture object 360 or the first expanded object 370. The processor 120 may dispose the items along an object boundary 380a of the second expanded object 380.

According to an embodiment, the length of the object boundary 380a of the second expanded object 380 may be longer than the length of the object boundary 370a of the first expanded object 370. The processor 120 may dispose a greater number of items (icons or stickers) than in the second state. The processor 120 may additionally dispose an icon of an application with high usage frequency or high usability among icons that are not selected by the user.

According to an embodiment, the processor 120 may display widgets 381 and 382 or at least one separate background sticker 385 outside or inside the second expanded object 380. The internal widget 381 may be disposed so as not to overlap the object boundary 380a or the items disposed along the object boundary 380a inside the gesture object 320. The internal widget 381 may have a different shape or size from the widget 371 inside the first expanded object 370. The external widget 382 may be disposed outside the gesture object 320 so as not to overlap the object boundary 380a or the items disposed along the object boundary 380a. The background sticker 385 may be disposed in various ways around the second expanded object 380, and may be a part of the background.

Referring to FIG. 1 and FIG. 3C, a ninth screen 3901 and a tenth screen 3902 may be home screens displayed on the display 160 of the electronic device 101 in the first state (or the reduced state, the minimized state).

According to an embodiment, in the ninth screen 3901, the processor 120 may receive a gesture input 3910 of the user. The gesture input 3910 may be an input that involves touching the display 160 with a part of a user's body and moving the part while drawing a figure or a shape.

According to an embodiment, in the tenth screen 3902, the processor 120 may determine a gesture object (e.g., a shape, a figure, a character) 3920 corresponding to the gesture input 3910 of the user. The processor 120 may determine the gesture object 3920 similar to the shape or line of the gesture input 3910 of the user.

According to an embodiment, the processor 120 may dispose items along a portion of a boundary of the gesture object 3920. For example, when the gesture object 3920 is in the shape of a yacht, the processor 120 may dispose items (e.g., an icon for executing an application, a sticker, or a folder icon) along a boundary of a first portion (e.g., a hull of the yacht) 3920a of the relatively large gesture object 3920. The processor 120 may not dispose an icon, a sticker, or a folder icon on a boundary of a second portion (e.g., a yacht flag) 3920b of the relatively small gesture object 3920.

According to an embodiment, an eleventh screen 3903 may be a home screen displayed in the second state (or the first expanded state) in which the display 160 of the electronic device 101 is primarily expanded. In the second state, the display region where the items are displayed may be expanded compared to the first state.

According to an embodiment, in the eleventh screen 3903, the processor 120 may display a first associated object 3930 and a second associated object 3940 associated with the gesture object 3920 based on generative artificial intelligence. The processor 120 may analyze the gesture object 3920 and generate a prompt corresponding to the gesture object 3920. For example, the corresponding prompt may include information about the size of the display together with information about the gesture object 3920 (e.g., an object type, characteristics). The processor 120 may generate and dispose the first associated object 3930 (e.g., a sea) or the second associated object 3940 (e.g., a different type of yacht) that is related to the gesture object 3920 (e.g., the yacht) and has a size optimized for the size of the display through generative artificial intelligence based on the generated prompt.

According to an embodiment, the processor 120 may dispose the items along an inner boundary 3930a of the first associated object 3930. The processor 120 may not dispose separate items on an outer boundary 3930b of the second associated object 3940.

According to an embodiment, the processor 120 may add a widget 3931 or a separate background sticker to an empty space around the first associated object 3930 or inside the first associated object 3930. For example, the widget 3931 may be disposed along the outer boundary 3930b so as not to overlap the items disposed along the inner boundary 3930a.

According to an embodiment, a twelfth screen 3904 may be a home screen displayed in the third state (or the second expanded state, the maximum expanded state) in which the display 160 of the electronic device 101 is secondarily expanded. In the third state, the display region where the items are displayed may be expanded compared to the second state.

According to an embodiment, in the twelfth screen 3904, the processor 120 may display the expanded object 3940 in which the gesture object 3920 is expanded. The expanded object 3940 may have a shape identical to or similar to the gesture object 3920, and may be an object having a greater size than the first expanded object 370. The processor 120 may dispose an icon and a sticker 3945 along a first boundary 3940a of a first portion of the expanded object 3940 where no separate widget is disposed. The processor 120 may not dispose separate items on a second boundary 3940b of a second portion of the expanded objects 3940 where a separate widget 3941 is disposed. The processor 120 may display a widget 3941 inside the second portion of the expanded object 3940.

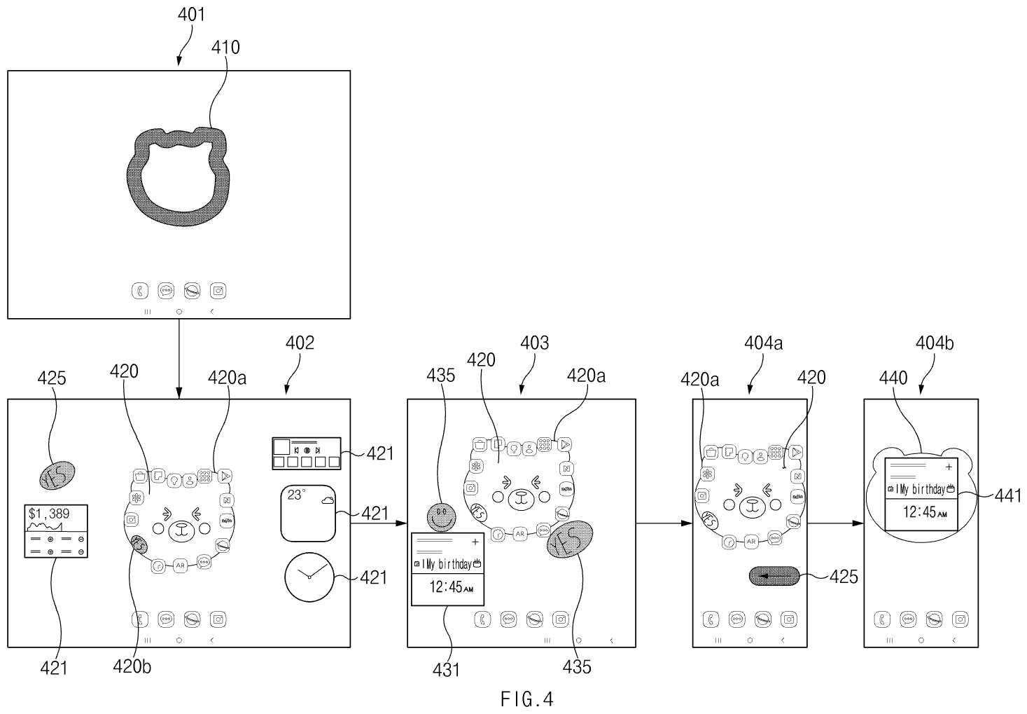

FIG. 4 illustrates a home screen displayed on the electronic device in which the display is reduced according to an embodiment.

Referring to FIG. 1 and FIG. 4, the first screen 401 and the second screen 402 may be home screens displayed in a third state (or a maximum expanded state) in which the display 160 of the electronic device 101 is fully expanded.

According to an embodiment, in the first screen 401, the processor 120 may receive a gesture input (or an interaction input) 410 of the user. The gesture input 410 may be an input that involves touching the display 160 with a part of a user's body and moving the part while drawing a figure or a shape.

According to an embodiment, in the second screen 402, the processor 120 may determine a gesture object (e.g., a shape, a figure, a character) 420 corresponding to the gesture input 410 of the user. The processor 120 may determine the gesture object 420 similar to the shape or line of the gesture input 410 of the user.

According to an embodiment, the processor 120 may determine the gesture object 420 by reflecting a user's preference. The processor 120 may compare the gesture input 410 with an object recognized on a webpage frequently visited by the user, an object recognized in a gallery app displaying captured images and an object included in a pre-stored database related to the gesture input 410. The processor 120 may determine an object with a high similarity to the gesture input 410 as the gesture object 420.

According to an embodiment, the processor 120 may dispose items along an object boundary 420a of the gesture object 420. For example, the disposed items may be icons that execute an application, folder icons, or stickers (sticker images).

According to an embodiment, the processor 120 may add a widget 421 or a separate background sticker 425 to an empty space around the gesture object 420. The widget 421 may be disposed separately so as not to overlap the gesture object 420 outside the gesture object 420. The background sticker 425 may be disposed separately so as not to overlap the gesture object 420, or may be disposed so that at least a portion thereof overlaps the gesture object 420. The background sticker 425 may have a different shape or size from the sticker 420b disposed along the object boundary 420a.

According to an embodiment, a third screen 403 may be a home screen displayed in a second state (or a first reduced state) in which the display 160 of the electronic device 101 is primarily reduced. In the third screen 403 of the second state, a display region where the items are displayed may be reduced compared to the first screen 401 and the second screen 402 in the third state. For example, the third screen 403 may be displayed when a foldable electronic device is folded or when a rollable electronic device is slid and stored.

According to an embodiment, in the third screen 403, the processor 120 may dispose the items along the object boundary 420a of the gesture object 420 in the same or similar manner as in the second screen 402. The processor 120 may partially remove or reduce a widget 431 or background sticker 435 disposed in an empty space around the gesture object 420.

According to an embodiment, a fourth screen 404a and a fifth screen 404b may be home screens displayed on the display 160 of the electronic device 101 in the first state (or the second reduced state, the minimized state).

According to an embodiment, the fourth screen 404a may be a first page of the home screen in the first state. In the first state, the processor 120 may maintain the gesture object 420 and remove all widgets or background stickers around the gesture object 420.

According to an embodiment, the fifth screen 404b may be a second page of the home screen in the first state. The processor 120 may switch between the fourth screen 404a and the fifth screen 404b by a page switching input 425.

According to an embodiment, on the second page of the fifth screen 404b, the processor 120 may display a simplified object 440 corresponding to an external shape of the gesture object 420 and may not display any widget or background sticker around the gesture object 420. A widget 441 may be displayed inside the simplified object 440, and separate items may not be displayed on a boundary of the simplified object 440.

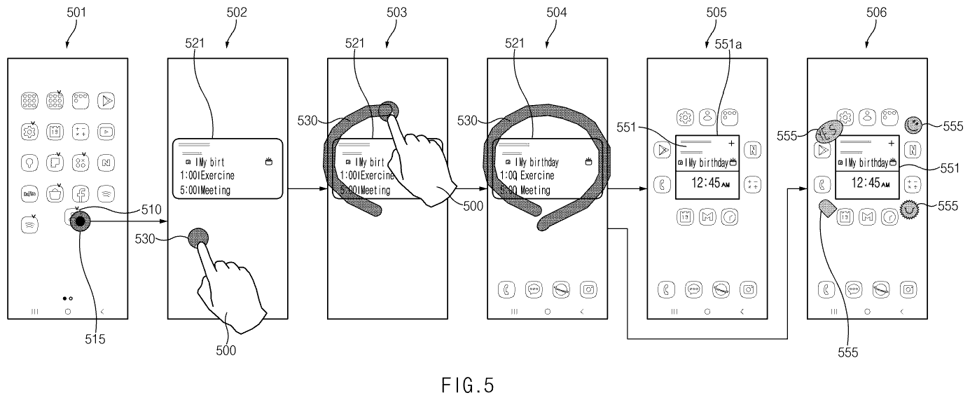

FIG. 5 illustrates a home screen on which widgets are disposed according to an embodiment.

Referring to FIG. 1 and FIG. 5, in an application selection screen 501, the processor 120 may display a list of applications (app list) installed in the electronic device 101. A plurality of icons may be selected based on a specified user input. For example, when a long press input occurs, a user interface may be displayed to select at least one in the app list.

According to an embodiment, after at least one application is selected, when a specified start input (e.g., a long press input) 515 occurs, the processor 120 may switch the screen from the application selection screen 501 to a home screen 502. After switching to the home screen 502, a gesture input 530 using a part of a user 500's body may be started. The start input 515 and the gesture input 530 may be continuous inputs in a state where touching is maintained.

According to an embodiment, the home screen 502 may be in a state in which a first widget 521 is disposed by default or user input. The first widget 521 may have a first size.

According to an embodiment, on a home screen 503 and the home screen 504, the gesture input 530 may be an input that draws a shape similar to a specific pattern (e.g., a circle) around the first widget 521. When a region selected by the gesture input 530 overlaps the first widget 521 by a specified ratio or more or includes the first widget 521, the processor 120 may determine that the first widget 521 is selected by the gesture input 530.

According to an embodiment, on a home screen 505 and a home screen 506, the processor 120 may display a second widget 551 obtained by modifying the first widget 521 in a basic form. The second widget 551 may perform the same or similar function as the first widget 521. The second widget 551 may be reduced in length or size compared to the first widget 521 and thus, may have a second size where items may be disposed therearound.

According to an embodiment, when the first widget 521 is selected by the gesture input 530 on the home screen 505, the processor 120 may dispose the items around the second widget 551. For example, the processor 120 may dispose the items so that the items are arranged along or aligned with a widget boundary 551a outside the second widget 551 so that the items do not overlap the second widget 551.

According to an embodiment, on the home screen 506, the processor 120 may dispose the items around the second widget 551 and additionally display a sticker 555. The sticker 555 may be disposed adjacent to a corner of the second widget 551. The sticker 555 may be displayed when the length of the widget boundary 551a is greater than the sum of the lengths of the items or at a point where it is difficult to dispose the items due to a grid shape.

According to an embodiment, on the home screen 505 and the home screen 506, a form in which items are disposed centered around the second widget 551 is discussed, but the form is not limited thereto. For example, when a space is secured to dispose the items around the first widget 521, the items may be displayed around the first widget 521 without changing the first widget 521 to the second widget 551.

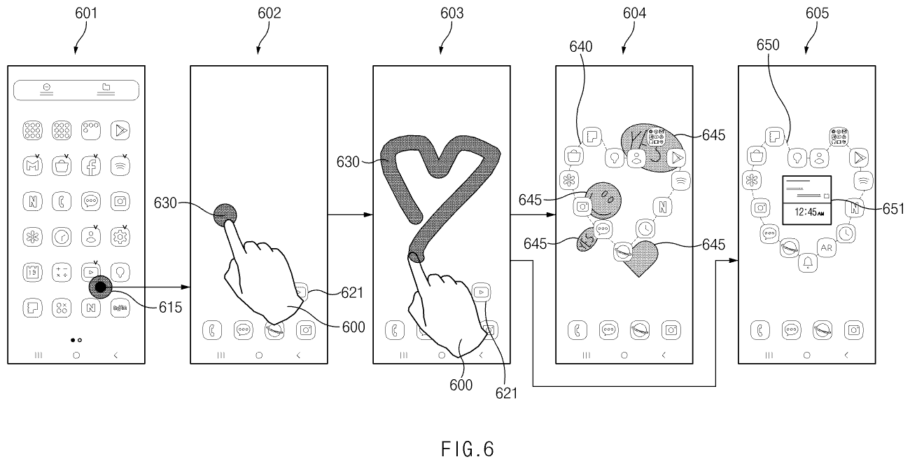

FIG. 6 illustrates a home screen on which stickers and widgets are disposed according to an embodiment.

Referring to FIG. 1 and FIG. 6, in an application selection screen 601, the processor 120 may display a list of applications (app list) installed in the electronic device 101. A plurality of icons may be selected based on a specified user input. For example, when a long press input occurs, a user interface may be displayed to select at least one in the app list.

After at least one application is selected, when a specified start input (e.g., a long press input) 615 occurs, the processor 120 may switch the screen from the application selection screen 601 to a home screen 602. After switching to the home screen 602, a gesture input 630 using a part of a user 600's body may be started. The start input 615 and the gesture input 630 may be continuous inputs in a state where touching is maintained.

According to an embodiment, a representative image (or an overlapping image) 621 of a plurality of items to be arranged by the gesture input 630 may be displayed on the home screen 602. For example, the representative image 621 may be displayed with a specified transparency to notify the user that the disposition of items is being performed through the gesture input 630. In a process of generating the gesture input 630, the representative image 621 may be fixed at a specified position, or may follow a periphery of the gesture input 630.

According to an embodiment, various shapes may be drawn on a home screen 603 by the gesture input 630. The gesture input 630 may be an input that involves touching the display 160 with a part of the user 600's body and moving the part while drawing a line, a figure, or a shape.

According to an embodiment, in a home screen 604 and a home screen 605, when there is no grid constraint, the processor 120 may freely dispose the items along a boundary of a gesture object 640. For example, a screen without the grid constraint (e.g., a home screen) may be in a screen form in which the items (e.g., icons) may be freely disposed without being predetermined in a grid form.

According to an embodiment, on the home screen 604, the processor 120 may determine a gesture object (or a selected region) (e.g., a heart) 640 corresponding to the gesture input 630. The gesture object 640 is not displayed on the home screen 604, and the gesture object 640 may be recognized by a disposed form of the items. The processor 120 may dispose the items along a boundary of the gesture object (e.g., the heart). The processor 120 may display a background sticker 645 as a part of the background.

According to an embodiment, on the home screen 605, the processor 120 may dispose the items along a boundary of a gesture object 650. The processor 120 may display a widget 651 inside the gesture object 650. The widget 651 may be determined as a widget of an application that the user frequently uses or is highly likely to use. A size of the widget 651 may be determined to be a size that may be included inside the gesture object 650. The processor 120 may dispose stickers, widgets, or app items in various ways using artificial intelligence (AI) logic.

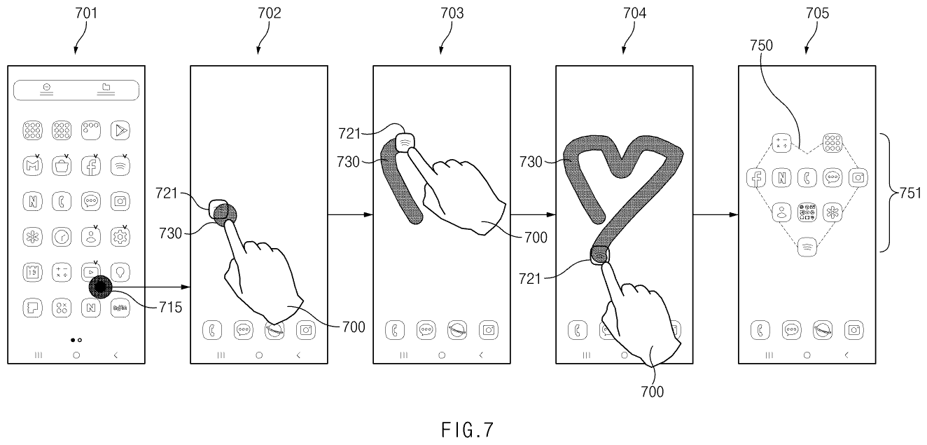

FIG. 7 illustrates a home screen with grid constraint according to an embodiment.

Referring to FIG. 1 and FIG. 7, in an application selection screen 701, the processor 120 may display a list of applications (app list) installed in the electronic device 101. A plurality of icons may be selected based on a specified user input. For example, when a long press input occurs, a user interface may be displayed to select at least one in the app list.

After at least one application is selected, when a specified start input (e.g., a long press input) 715 occurs, the processor 120 may switch the screen from the application selection screen 701 to a home screen 702. After switching to the home screen 702, a gesture input 730 using a part of a user 700's body may be started. The start input 715 and the gesture input 730 may be continuous inputs in a state where touching is maintained.

On the home screen 702, a representative image 721 of a plurality of items to be arranged by the gesture input 730 may be displayed with a specified transparency to notify the user that the disposition of the items is being performed by the gesture input 730. In the process of generating the gesture input 730, the representative image 721 may follow a path of the gesture input 730.

On the home screen 703 and a home screen 704, shapes of lines and figures may be drawn by the gesture input 730. The gesture input 730 may be a continuous touch input using a part of the user 700's body. The representative image 721 may follow the path of the gesture input 730.

On a home screen 705, the processor 120 may determine a gesture object (or a selected region) (e.g., a heart) 750 corresponding to the gesture input 730.

The processor 120 may dispose the items inside, on, and/or along the boundary of the gesture object (e.g., the heart) 750. When there is the grid constraint, the processor 120 may arrange the items in a standardized form 751 according to the disposition of an internal grid of the gesture object 740. A screen with the grid constraint (e.g., a home screen) may have a screen form in which the positions where the items (e.g., the icons) may be disposed are predetermined in a grid form, so that the position or the number of items (e.g., icons) that are possible to dispose is limited. The gesture object 750 is not displayed on the home screen 705, and the gesture object 750 may be recognized by the disposed form of the items.

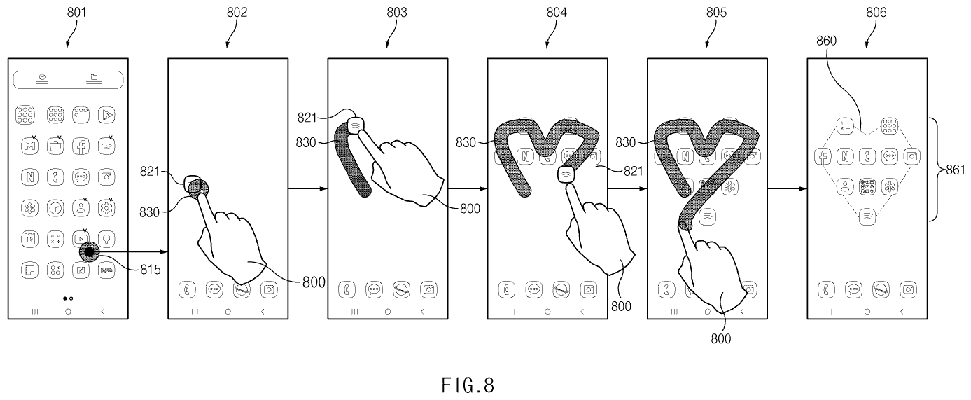

FIG. 8 illustrates a home screen on which items are disposed in real time according to an embodiment.

Referring to FIG. 1 and FIG. 8, in an application selection screen 801, the processor 120 may display a list of applications (app list) installed in the electronic device 101. A plurality of icons may be selected based on a specified user input. For example, when a long press input occurs, a user interface may be displayed to select at least one in the app list.

After at least one application is selected, when a specified start input (e.g., a long press input) 815 occurs, the processor 120 may switch the screen from the application selection screen 801 to a home screen 802. After switching to the home screen 802, a gesture input 830 using a part of a user 800's body may be started. The start input 815 and the gesture input 830 may be continuous inputs in a state where touching is maintained.

On the home screen 802, a representative image 821 of a plurality of items to be arranged by the gesture input 830 may be displayed with a specified transparency to notify the user that the disposition of the items is being performed by the gesture input 830. In the process of generating the gesture input 830, the representative image 821 may follow a path of the gesture input 830.

On the home screen 803, lines or shapes may be drawn by the gesture input 830. The gesture input 830 may be a continuous touch input using a part of the user 800's body.

On a home screen 804 and a home screen 805, the processor 120 may dispose the items in real time along a line along which the gesture input 830 occurs. When there is the grid constraint, the processor 120 may dispose the items considering a line along which the gesture input 830 occurs and a grid layout.

On a home screen 806, the processor 120 may determine a gesture object (or a selected region) (e.g., a heart) 860 corresponding to the gesture input 830. When the gesture object (e.g., the heart) 860 is determined, the processor 120 may correct the disposition of items disposed in real time by artificial intelligence (AI) logic. The processor 120 may dispose the items inside, on, and/or along the boundary of the gesture object (e.g., the heart) 860. When there is the grid constraint, the processor 120 may dispose the items in a standardized form 861 according to the shape of an internal grid of the gesture object 840. The gesture object 860 is not displayed on the home screen 806, and the gesture object 860 may be recognized by the disposed form of the items.

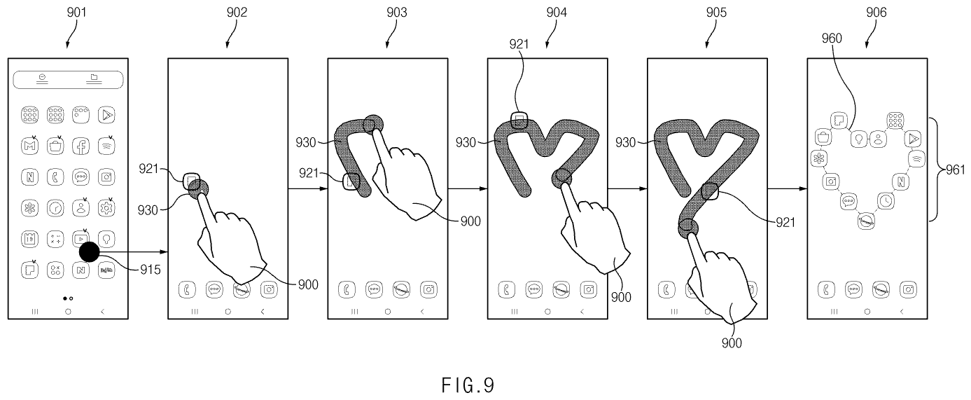

FIG. 9 illustrates a home screen without grid constraint according to an embodiment.

Referring to FIG. 1 and FIG. 9, in an application selection screen 901, the processor 120 may display a list of applications (app list) installed in the electronic device 101. A plurality of icons may be selected based on a specified user input. For example, when a long press input occurs, a user interface may be displayed to select at least one in the app list.

After at least one application is selected, when a specified start input (e.g., a long press input) 915 occurs, the processor 120 may switch the screen from the application selection screen 901 to a home screen 902. After switching to the home screen 902, a gesture input 930 using a part of a user 900's body may be started.

On the home screen 902, a representative image (or an overlapping image) 921 of a plurality of items to be arranged by the gesture input 930 may be displayed with a specified transparency to notify the user that the disposition of the items is being performed by the gesture input 930. In the process of generating the gesture input 930, the representative image 921 may follow a path of the gesture input 930.

On a home screen 903, a home screen 904, and a home screen 905, lines or shapes may be drawn by the gesture input 930. The gesture input 930 may be a continuous touch input using a part of the user 900's body. The representative image 921 may be displayed with a specified transparency and follow a path of the gesture input 930.

On a home screen 906, the processor 120 may determine a gesture object (or a selected region) (e.g., a heart) 960 corresponding to the gesture input 930. The processor 120 may dispose the items on a boundary of the gesture object (e.g., the heart) 960. When there is no grid constraint, the processor 120 may dispose the items in a free form 961 along the boundary of the gesture object 960. The gesture object 960 may not be displayed on the home screen 905, and the gesture object 960 may be recognized by a disposed form of the items.

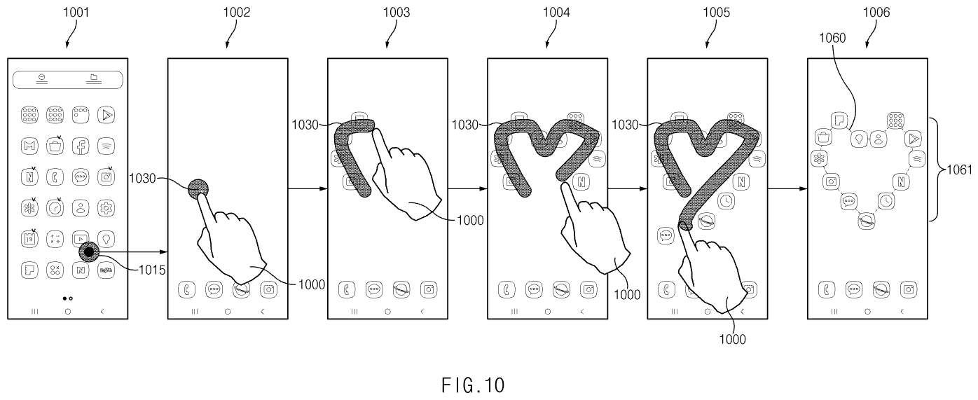

FIG. 10 illustrates a home screen without grid constraint and having items disposed in real time according to an embodiment.

Referring to FIG. 1 and FIG. 10, in an application selection screen 1001, the processor 120 may display a list of applications (app list) installed in the electronic device 101. A plurality of icons may be selected based on a specified user input. For example, when a long press input occurs, a user interface may be displayed to select at least one in the app list.

After at least one application is selected, when a specified start input (e.g., a long press input) 1015 occurs, the processor 120 may switch the screen from the application selection screen 1001 to a home screen 1002. After switching to the home screen 1002, a gesture input 1030 using a part of a user 1000's body may be started.

On a home screen 1003, a home screen 1004, and a home screen 1005, a shape desired by the user 1000 may be drawn by the gesture input 1030. The processor 120 may dispose the items in real time along a line where the gesture input 1030 occurs. When there is no grid constraint, the processor 120 may freely dispose the items by reflecting the line where the gesture input 1030 occurs. For example, the processor 120 may arrange items having a specified transparency along a path of the gesture input 1030.

On a home screen 1006, the processor 120 may determine a gesture object (or a selected region) (e.g., a heart) 1060 corresponding to the gesture input 1030. When the gesture object (e.g., the heart) 1060 is determined, the processor 120 may correct the disposition of items disposed in real time by artificial intelligence (AI) logic.

The processor 120 may dispose the items on a boundary of the gesture object (e.g., the heart) 1060. When there is no grid constraint, the processor 120 may dispose the items in a free form 1061 along the boundary of the gesture object 1060. The gesture object 1060 may not be displayed on the home screen 1006, and the gesture object 1060 may be recognized by a disposed form of the items.

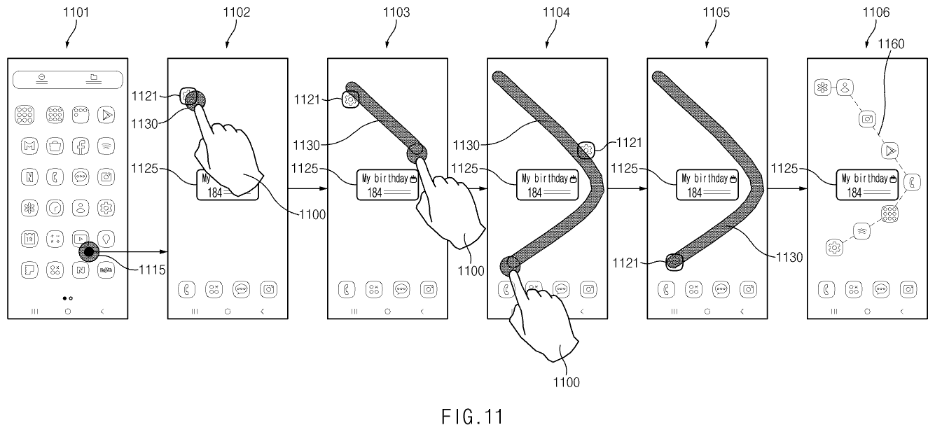

FIG. 11 illustrates a home screen according to widget disposition according to an embodiment.

Referring to FIG. 1 and FIG. 11, in an application selection screen 1101, the processor 120 may display an app list. A plurality of items may be selected based on a specified user input. For example, when a long press input occurs, a user interface may be displayed to select at least one in the app list.

After at least one application is selected, when a specified start input (e.g., a long press input) 1115 occurs, the processor 120 may switch the screen from the application selection screen 1101 to a home screen 1102. After switching to the home screen 1102, a gesture input 1130 using a part of a user 1100's body may be started.

On the home screen 1102, a representative image (or an overlapping image) 1121 of a plurality of items to be arranged by the gesture input 1130 may be displayed with a specified transparency to notify the user that the disposition of the items is being performed by the gesture input 1130. In the process of generating the gesture input 1130, the representative image 1121 may follow a path of the gesture input 1130.

According to an embodiment, the home screen 1102 may be in a state in which a widget 1125 is disposed by default or user input.

On a home screen 1103, a home screen 1104, and a home screen 1105, the gesture input 1130 may occur. The gesture input 1130 may be an input drawn so as not to overlap the widget 1125 or so as to overlap the widget 1125 in a specified ratio (e.g., 5%).

On a home screen 1106, when the gesture input 1130 is drawn so as not to overlap the widget 1125 or to overlap the widget 1125 in the specified ratio (e.g., 5%), the processor 120 may determine a line that does not overlap the widget 1125 as a gesture object 1160. The processor 120 may dispose the items along the gesture object 1160. The items may be disposed so as not to overlap the widget 1125.

The gesture object 1160 may not be displayed on the home screen 1106, and the gesture object 1160 may be recognized by the disposition of the items.

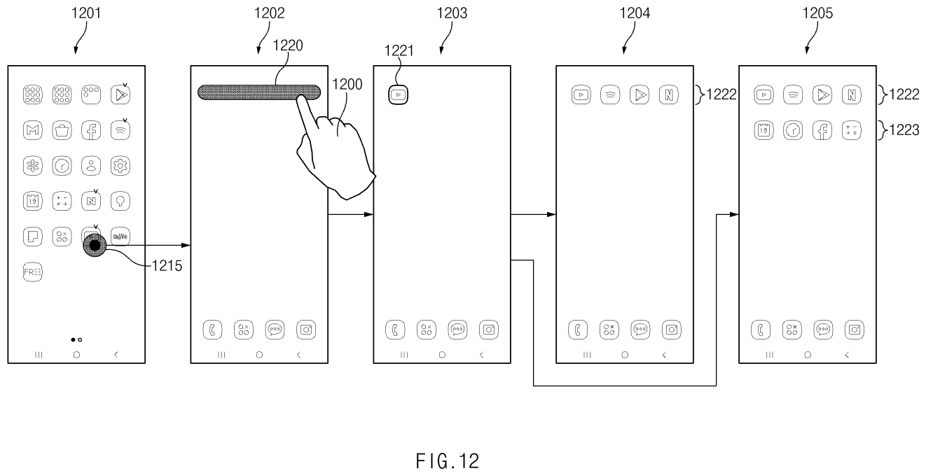

FIG. 12 illustrates a home screen according to a gesture and the number of items according to an embodiment.

Referring to FIG. 1 and FIG. 12, in an application selection screen 1201, the processor 120 may display a list of applications (app list) installed in the electronic device 101. A plurality of icons may be selected based on a specified user input. For example, when a long press input occurs, a user interface may be displayed to select at least one in the app list.

After at least one application is selected, when a specified start input (e.g., a long press input) 1215 occurs, the processor 120 may switch the screen from the application selection screen 1201 to a home screen 1202. After switching to the home screen 1202, a gesture input 1220 using a part of a user 1200's body may be started.

On the home screen 1202, the gesture input 1220 may occur. The gesture input 1220 may be an input in the form of a line facing a specified direction. For example, the gesture input 1220 may be an input that starts at a left edge of the display and extends to a right edge. The processor 120 may determine a straight line starting from the left edge of the display and ending at the right edge as a gesture object (not illustrated).

In a home screen 1203 and a home screen 1204, a plurality of items 1222 may be spread out to be arranged along the line of the gesture object in an overlapping form 1221.

In a home screen 1205, when a disposed length of the plurality of items is longer than a length of the gesture object, the processor 120 may dispose a plurality of gesture objects in the same or similar form and dispose the plurality of items along the plurality of gesture objects. For example, the processor 120 may arrange some items 1222 of the plurality of items along a first line of the gesture objects. The processor 120 may arrange other items 1223 of the plurality of items along a second line of the gesture objects.

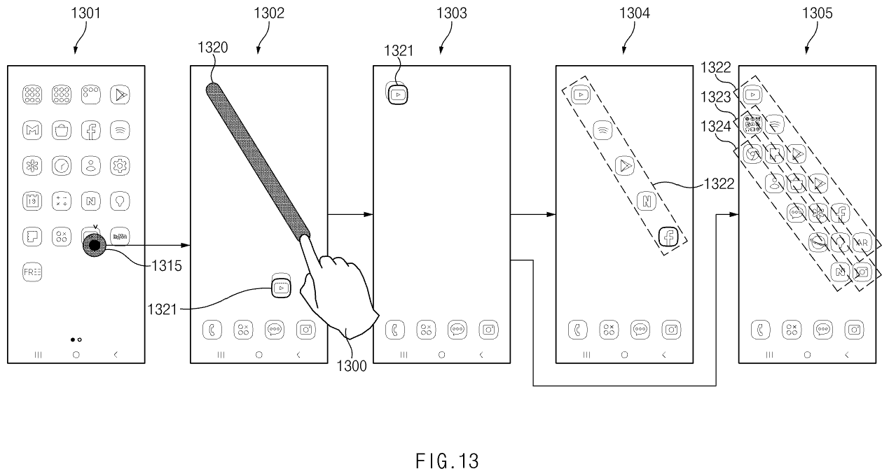

FIG. 13 illustrates a home screen according to a gesture and the number of items according to an embodiment.

Referring to FIG. 1 and FIG. 13, in an application selection screen 1301, the processor 120 may display a list of applications (app list) installed in the electronic device 101. A plurality of icons may be selected based on a specified user input. For example, when a long press input occurs, a user interface may be displayed to select at least one in the app list.

After at least one application is selected, when a specified start input (e.g., a long press input) 1315 occurs, the processor 120 may switch the screen from the application selection screen 1301 to a home screen 1302. After switching to the home screen 1302, a gesture input 1330 using a part of a user 1300's body may be started.

On the home screen 1302, the gesture input 1320 may occur. The gesture input 1320 may be an input in the form of a line facing a specified direction. For example, the gesture input 1320 may be an input that starts at a left upper end of the display and extends to a right lower end. The processor 120 may determine a straight line starting from the left upper end of the display and ending at the right lower end as a gesture object (not illustrated).

On the home screen 1302, a representative image (or an overlapping image) 1321 of a plurality of items to be arranged by the gesture input 1320 may be displayed with a specified transparency to notify the user that the disposition of the items is being performed by the gesture input 1320. In a process of generating the gesture input 1320, the representative image 1321 may be fixed at a specified position, or may follow a periphery of the gesture input 1320.

In a home screen 1303 and a home screen 1304, a plurality of items may be changed from an overlapping form 1321 to a spread form 1322 to be arranged along a line of the gesture object.

In a home screen 1305, when a disposed length of the plurality of items is longer than a length of the gesture object, the processor 120 may dispose a plurality of gesture objects in the same or similar form and dispose the plurality of items along the plurality of gesture objects.

For example, the processor 120 may arrange a first group 1322 of the plurality of items along a first line of the gesture object. The processor 120 may arrange a second group 1323 of the plurality of items along a second line of the gesture object. The processor 120 may arrange a third group 1324 of the plurality of items along a third line of the gesture object.

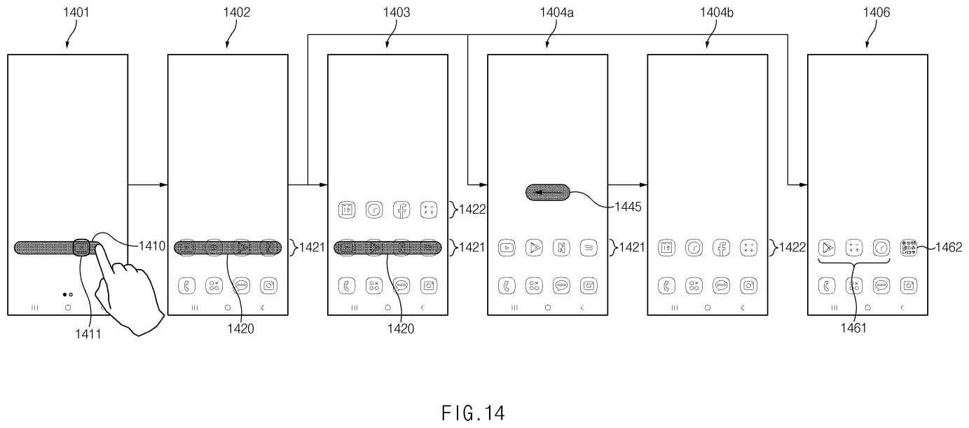

FIG. 14 illustrates a home screen according to a gesture and the number of items according to an embodiment.

Referring to FIG. 1 and FIG. 14, on a home screen 1401 and a home screen 1402, a gesture input 1410 may occur. The gesture input 1410 may be an input in the form of a line facing a specified direction. For example, a gesture input 1420 may be an input that, at a lower end of the display, starts at a left edge of the display and extends to a right edge. The processor 120 may determine a straight line starting from the left edge of the display and ending at the right edge as a gesture object (not illustrated). The processor 120 may arrange a plurality of items 1410 along a line of the gesture object.

In a home screen 1403, when a disposed length of the plurality of items is longer than a length of the gesture object, the processor 120 may dispose a plurality of gesture objects in the same or similar form and dispose the plurality of items along the plurality of gesture objects.

For example, the processor 120 may arrange a first group 1421 of the plurality of items along a first line of the gesture object. The processor 120 may arrange a second group 1422 of the plurality of items along a second line of the gesture object.

In a home screen 1404a and a home screen 1404b, the processor 120 may switch between the home screen 1404a and the home screen 1404b by a page switching input 1445. When a disposed length of the plurality of items is longer than a length of the gesture object, the processor 120 may dispose a plurality of gesture objects in the same or similar form on different pages. The processor 120 may dispose the plurality of items along the plurality of gesture objects disposed on the different pages.

For example, on the home screen 1404a, the processor 120 may arrange a first group 1421 of the plurality of items along a first line of a first page. On the home screen 1404b, the processor 120 may arrange a second group 1422 of the plurality of items along a second line of a second page.

On a home screen 1406, when the disposed length of the plurality of items is longer than the length of the gesture object, the processor 120 may generate a folder and store some of the plurality of items in the folder. The processor 120 may dispose some items 1461 of the plurality of items and a folder icon 1462 along a gesture object (not illustrated).

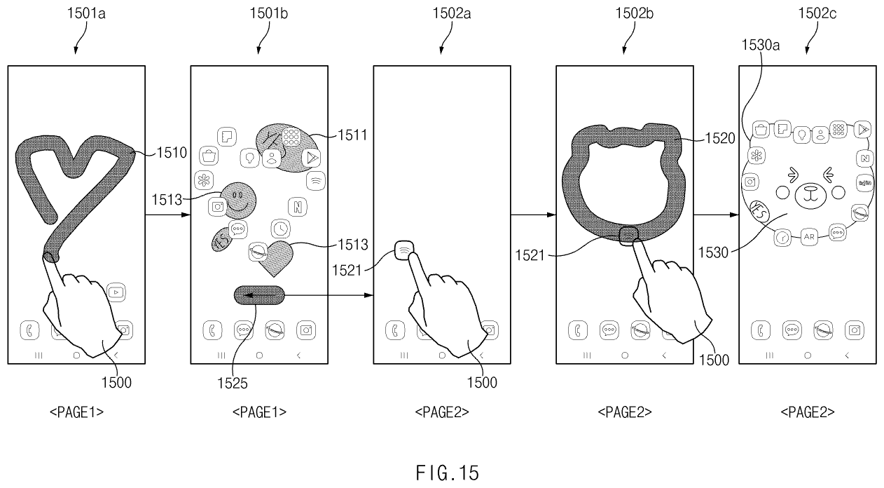

FIG. 15 illustrates a home screen that receives a gesture input for each page according to an embodiment.

Referring to FIG. 1 and FIG. 15, the processor 120 may configure the home screen into a plurality of pages. The processor 120 may switch pages of the home screen by a page switching input 1525.

On a first page 1501a of the home screen, a gesture input 1510 may occur. The gesture input 1510 may be an input that involves touching the display 160 with a part of the user 1500's body and moving the part while drawing a figure, or a shape.

On a first page 1501b of the home screen, the processor 120 may determine a first gesture object (e.g., a heart shape or a figure) corresponding to the user's first gesture input 1510. The processor 120 may determine the first gesture object (e.g., the heart) similar to the shape of the user's first gesture input 1510. The processor 120 may dispose items along a boundary of the first gesture object. For example, the disposed items may be icons that execute applications, folder icons, or sticker images. The processor 120 may display various background stickers 1511 and 1513.

When the page switching input 1525 occurs, the processor 120 may switch pages of the home screen.

On the second pages 1502a and 1502b of the home screen, a second gesture input 1520 different from the first gesture input 1510 of the first pages 1501a and 1501b may be initiated by a touch input of a part of the user 1500's body. The second gesture input 1520 may be an input that involves touching the display 160 with a part of the user 1500's body and moving the part while drawing a figure or a shape.

A plurality of item images 1521 may be displayed around the second gesture input 1520 with a specified transparency so that the item images 1521 may move together along the path of the gesture input 1520.

On a second page 1502c of the home screen, the processor 120 may determine a second gesture object (e.g., a shape, a figure, a character) 1530 corresponding to the gesture input 1520 of the user. The processor 120 may determine the gesture object 1530 similar to the shape of the gesture input 1520 of the user.

The processor 120 may dispose the items along an object boundary 1530a of the gesture object 1530. For example, the disposed items may be icons that execute applications, folder icons, or stickers.

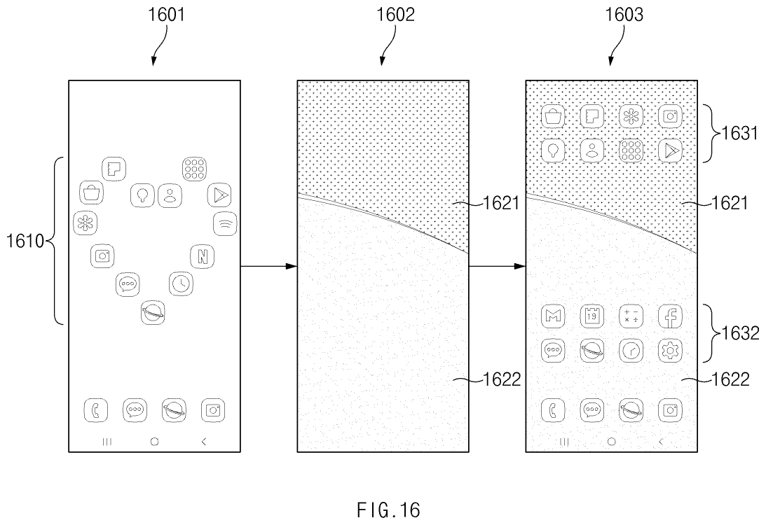

FIG. 16 illustrates a home screen according to a change in a background image according to an embodiment.

Referring to FIG. 1 and FIG. 16, in a first screen 1601, the processor 120 may dispose a plurality of items 1610 along a gesture object (e.g., a heart) determined according to a gesture input of the user.

In a second screen 1602, the processor 120 may change a background image by a specified setting or user input. For example, the background image may include a first region 1621 of a first color and a second region 1622 of a second color.

In a third screen 1603, when the background image is changed, the processor 120 may re-dispose a plurality of items according to the characteristics of the background image. The processor 120 may compare the color of each of the plurality of items 1610 with the first color and the second color, and divide the plurality of items 1610 into a first group 1631 similar to the first color and a second group 1632 similar to the second color.

In FIG. 16, each of the first group 1631 and the second group 1632 is illustrated as being disposed in a line shape, but the shape thereof is not limited thereto. For example, the first group 1631 may be disposed in the first region 1621 so that the gesture object corresponds to a reduced shape (e.g., a small heart), and the second group 1632 may be disposed in the second region 1622 so that the gesture object corresponds to a reduced shape (e.g., a small heart).

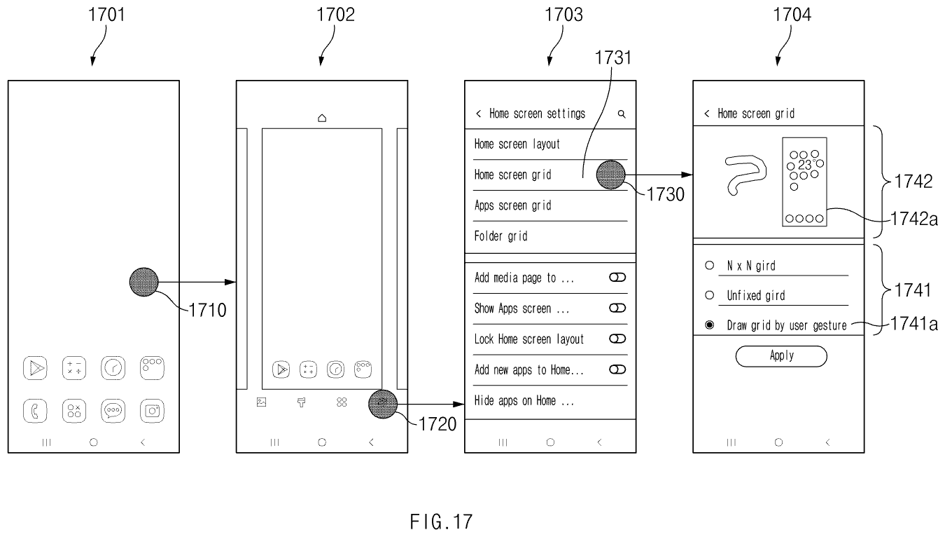

FIG. 17 illustrates settings of a home screen according to an embodiment. FIG. 17 is exemplary and is not limited thereto.

Referring to FIG. 1 and FIG. 17, in a first screen 1701, the processor 120 may display a second screen 1702 for changing the home screen when a specified user input (e.g., a long touch input) 1710 occurs.

In the second screen 1702, when a user input 1720 occurs on a setting button of the home screen, the processor 120 may display a third screen 1703 for setting the home screen in detail.

In the third screen 1703, the processor 120 may display a plurality of lists related to settings of the home screen. When a home screen grid setting option 1731 is selected 1730 from among the plurality of lists, the processor 120 may display a fourth screen 1704 including a user interface for grid setting.

The user interface for grid setting may include a first region 1741 that includes grid layout related options and a second region 1742 that displays examples of the disposition of items.

When an option 1741a regarding disposition of the plurality of items by the gesture input is selected in the first region 1741, the processor 120 may display an example 1742a regarding disposition of the plurality of items by the gesture input in the second region 1742.

An electronic device disposes items on a home screen in a simple manner when the size of a display is expanded or reduced. When the size of the display is expanded, the disposition of the items displayed on the home screen are maintained or the items are simply re-disposed. Alternatively, when the size of the display is reduced, the items displayed on the home screen simply return to the item disposition before the display is expanded.

An electronic device according to an embodiment may include a display, a memory, and at least one processor including processing circuitry. The memory may store instructions that, when individually or collectively executed by the at least one processor, cause the electronic device to determine an item group including at least one icon for executing an application installed in the electronic device, receive a gesture input of a user through the display, determine a first object corresponding to the gesture input, and arrange items included in the item group on the display based on a shape of the first object.

According to an embodiment, the instructions, when executed by the at least one processor, may cause the electronic device to determine at least one additional item associated with the item group and display the at least one additional item together with the items on the display.

According to an embodiment, the at least one additional item may be a widget, a sticker image, or a separate item not included in the item group.

According to an embodiment, the instructions, when executed by the at least one processor, may cause the electronic device to dispose the widget on the display so as not to overlap a first boundary of the first object or the items.

According to an embodiment, the instructions, when executed by the at least one processor, may cause the electronic device to arrange the sticker image or the separate item on a first boundary of the first object.

According to an embodiment, the instructions, when executed by the at least one processor, may cause the electronic device to dispose the sticker image inside or outside a first boundary of the first object, or to display the sticker image on the display as a part of a background overlapping the first boundary.

According to an embodiment, the instructions, when executed by the at least one processor, may cause the electronic device to arrange the items on a first boundary of the first object.

According to an embodiment, the instructions, when executed by the at least one processor, may cause the electronic device to arrange the items by comparing a length of the first boundary with an arrangement length of the items.

According to an embodiment, the instructions, when executed by the at least one processor, may cause the electronic device to arrange a sticker image on or along the first boundary when the length of the first boundary is longer than the arrangement length of the items.

According to an embodiment, the instructions, when executed by the at least one processor, may cause the electronic device to generate a folder storing at least some of the items when the length of the first boundary is shorter than the arrangement length of the items and arrange an icon of the folder together with others of the items on or along the first boundary.

According to an embodiment, the instructions, when executed by the at least one processor, may cause the electronic device to detect a change in a size of the display, change a size or a shape of the first object to generate a second object, and arrange the items on the display based on the shape of the second object.

According to an embodiment, the instructions, when executed by the at least one processor, may cause the electronic device to generate the second object associated with the first object and having a greater size than the first object when the size of the display is expanded and arrange the items on or along a second boundary of the second object.

According to an embodiment, the instructions, when executed by the at least one processor, may cause the electronic device to arrange a recommended item related to the user together with the items on or along the second boundary.

According to an embodiment, the instructions, when executed by the at least one processor, may cause the electronic device to generate a third object associated with the first object and having a smaller size than the first object when the size of the display is reduced and arrange the items on or along a third boundary of the third object.

According to an embodiment, the instructions, when executed by the at least one processor, may cause the electronic device to generate a folder storing at least some of the items and arrange an icon of the folder together with others of the items on or along the third boundary.

According to an embodiment, the instructions, when executed by the at least one processor, may cause the electronic device to arrange the items based on the shape of the first object and a grid layout when grid constraint is set on the display.

According to an embodiment, the instructions, when executed by the at least one processor, may cause the electronic device to determine the first object as a plurality of objects having the same shape and arrange the items based on a disposed form of the plurality of objects.

A method for displaying items according to an embodiment may be performed on an electronic device, and may include determining an item group including at least one icon for executing an application installed in the electronic device, receiving a gesture input of a user through a display of the electronic device, determining a first object corresponding to the gesture input, and arranging items included in the item group on the display based on a shape of the first object.

According to an embodiment, the method may further include determining at least one additional item associated with the item group and displaying the at least one additional item together with the items on the display.

According to an embodiment, the method may include detecting a change in a size of the display, generating a second object by changing a size or a shape of the first object, and arranging the items on the display based on the shape of the second object.

An electronic device according to an embodiment disclosed herein may arrange items on a home screen in various ways based on a gesture input of a user.

An electronic device according to an embodiment disclosed herein may dispose items along a boundary of an object determined by a gesture input, and dispose an additional item according to the length of the items.

An electronic device according to an embodiment disclosed herein may reduce, enlarge, or change an object determined based on a gesture input when the size of a display is expanded or reduced. The electronic device may provide diverse user experiences by arranging items based on the changed object.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
a display;
memory; and
at least one processor including processing circuitry,
wherein the memory stores one or more instructions that, when individually or collectively executed by the at least one processor, cause the electronic device to:
determine an item group, the item group comprising at least one icon for executing an application installed in the electronic device;
receive a gesture input of a user through the display;
determine a first object corresponding to the gesture input; and
arrange one or more items included in the item group on the display based on a shape of the first object.

2. The electronic device of claim 1, wherein the one or more instructions, when executed by the at least one processor, further cause the electronic device to:
determine at least one additional item associated with the item group; and
display the at least one additional item together with the one or more items on the display.

3. The electronic device of claim 2, wherein the at least one additional item is a widget, a sticker image, or a separate item not included in the item group.

4. The electronic device of claim 3, wherein the one or more instructions, when executed by the at least one processor, further cause the electronic device to display the widget on the display such that there is no overlap between the widget and a first boundary of the first object or such that there is no overlap between the widget and the one or more items in the item group.

5. The electronic device of claim 3, wherein the one or more instructions, when executed by the at least one processor, further cause the electronic device to arrange the sticker image or the separate item along a first boundary of the first object.

6. The electronic device of claim 3, wherein the one or more instructions, when executed by the at least one processor, further cause the electronic device to:
display the sticker image on a first side or a second side of a first boundary of the first object, or
display the sticker image on the display as a part of a background that is overlapping the first boundary.

7. The electronic device of claim 1, wherein the one or more instructions, when executed by the at least one processor, further cause the electronic device to arrange the one or more items in the item group along a first boundary of the first object.

8. The electronic device of claim 7, wherein the one or more instructions, when executed by the at least one processor, further cause the electronic device to arrange the one or more items in the item group based on a comparison of a length of the first boundary with an arrangement length of the one or more items.

9. The electronic device of claim 8, wherein the one or more instructions, when executed by the at least one processor, further cause the electronic device to, based on the length of the first boundary being longer than the arrangement length of the one or more items, arrange a sticker image along the first boundary.

10. The electronic device of claim 8, wherein the one or more instructions, when executed by the at least one processor, further cause the electronic device to:
generate an icon of a folder that stores at least some of the one or more items when the length of the first boundary is shorter than the arrangement length of the one or more items; and
arrange the icon of the folder together with others of the one or more items along the first boundary.

11. The electronic device of claim 1, wherein the one or more instructions, when executed by the at least one processor, further cause the electronic device to:
detect a change in a size of the display;
based on detecting the change, generate a second object using the first object; and
arrange the items on the display based on the shape of the second object.

12. The electronic device of claim 11, wherein the one or more instructions, when executed by the at least one processor, further cause the electronic device to:
based on the change being an expansion in the size of the display, generate the second object associated with the first object and having a greater size than the first object; and
arrange the items along a second boundary of the second object.

13. The electronic device of claim 12, wherein the one or more instructions, when executed by the at least one processor, further cause the electronic device to arrange a recommended item related to the user together with the items along the second boundary.

14. The electronic device of claim 11, wherein the one or more instructions, when executed by the at least one processor, further cause the electronic device to:
based on the change being a reduction in the size of the display, generate a third object associated with the first object and having a smaller size than the first object; and
arrange the items along a third boundary of the third object.

15. The electronic device of claim 14, wherein the one or more instructions, when executed by the at least one processor, further cause the electronic device to:
generate an icon of a folder storing at least some of the one or more items; and
arrange the icon of the folder together with others of the one or more items along the third boundary.

16. The electronic device of claim 1, wherein the one or more instructions, when executed by the at least one processor, further cause the electronic device to arrange the one or more items in the shape of the first object and in a grid layout on the display based on a grid constraint being set on the display.

17. The electronic device of claim 1, wherein the one or more instructions, when executed by the at least one processor, further cause the electronic device to:
determine the first object as a plurality of objects having a same shape; and
arrange the one or more items on the display based on a form of the plurality of objects.

18. A method for displaying items performed on an electronic device, comprising:
determining an item group, the item group comprising at least one icon for executing an application installed in the electronic device;
receiving a gesture input of a user through a display of the electronic device;
determining a first object corresponding to the gesture input; and
arranging one or more items included in the item group on the display based on a shape of the first object.

19. The method of claim 18, further comprising:
determining at least one additional item associated with the item group; and
displaying the at least one additional item together with the one or more items on the display.

20. The method of claim 18, comprising:
detecting a change in a size of the display;
based on the change being detected, generating a second object based on the shape of the first object; and
arranging the items on the display based on the shape of the second object.
